(19) United States
(12) Patent Application Publication
(10) Pub. No.: US 2018/0260588 A1
(43) Pub. Date: Sep. 13, 2018

(54) AN ELECTRONIC CARD ASSEMBLY, AN ELECTRONIC DEVICE AND A METHOD FOR USING THEREOF

(71) Applicant: SIRIN ADVANCED TECHNOLOGIES LTD., Tel Aviv (IL)

(72) Inventors: Assaf Shafir, Tel Aviv (IL); Maxim Feldman, Petah Tikva (IL); Sagiv Zeltser, Netanya (IL)

(21) Appl. No.: 15/571,335

(22) PCT Filed: Apr. 20, 2016
(86) PCT No.: PCT/IL2016/050417

§ 371 Date: Nov. 2, 2017

(30) Foreign Application Priority Data
May 3, 2015 (IL) 238581

(51) Int. Cl. G06K 7/00

(52) U.S. Cl. CPC G06K 7/0021; G06K 7/006

(57) ABSTRACT

An electronic device comprising: a device housing; an electronic card assembly disposed in said device housing and comprising: a card housing configured with a housing opening; a card tray having a card receiving space for accommodating an electronic card, said card tray being slidably displaceable between a closed position in which it is at least partially disposed within the card housing, and an open position in which it projects from the card housing to an extent greater than in said closed position; a locking mechanism configured between a locked state in which said card tray is arrested in its closed position and an unlocked state in which the card tray is free to be displaced; a driving mechanism configured for displacing the card tray at least from its closed position into its open position; and a control unit in communication with the locking mechanism and with the driving mechanism, said control unit configured for outputting an unlocking signal to the locking mechanism, thereby changing the state of the locking mechanism from its locked state to its unlocked state; and a driving signal to the driving mechanism, thereby displacing the card tray from its closed position into its open position.

### TECHNOLOGICAL FIELD

The presently disclosed subject matter is related to devices and methods for electronic cards insertable to and ejectable from electronic devices.

### BACKGROUND

Electronic memory cards for storing data are used in many electronic devices, such as mobile phones, tablets, video cameras, digital still cameras, PDA's, music players, ATMs, cable television decoders, toys, games, PC adapters, multi-media cards and other electronic applications. An electronic card assembly is a card reader, which typically is part of an electronic device, used to read data from the electronic card and transmit the data to the electronic device. The card reader may also be used to write data from the electronic device to the electronic card. One aspect of the electronic card assemblies mounted on such electronic devices is that they have an ejection mechanism for removing an inserted electronic card therefrom.

The electronic card can be, for example, a subscriber identity module (SIM) card or a memory card. A SIM card is configured to store network-specific information used to authenticate and identify subscribers on the communication network. The information on the SIM card is used by the network to control and configure access by the device to the network.

Hereinafter in the specification and claims, the term ‘electronic card’ relates to any type of such removable card, used in conjunction with an electronic device (portable, or stationary), such as a SIM (subscriber identity module) card, a memory card (e.g. SD card) etc.

The term ‘electronic device’ refers hereinafter in the specification and the claims to a mobile phone, a tablet device, a computer, a PDA, a portable audio device, a video player, a game player, a camera, or any other device in which an electronic card assembly can be utilized.

### GENERAL DESCRIPTION

According to one aspect of the presently disclosed subject matter there is disclosed an electronic device comprising:
a device housing;
an electronic card assembly disposed in said device housing and comprising:
   a card housing configured with a housing opening;
   a card tray having a card receiving space for accommodating an electronic card, said card tray being slidably displaceable between a closed position in which it is at least partially disposed within the card housing, and an open position in which it projects from the card housing to an extent greater than in said closed position;
   a locking mechanism configured between a locked state in which said card tray is arrested in its closed position and an unlocked state in which the card tray is free to be displaced;
   a driving mechanism configured for displacing the card tray at least from its closed position into its open position; and
a control unit in communication with the locking mechanism and with the driving mechanism, said control unit configured for outputting an unlocking signal to the locking mechanism, thereby changing the state of the locking mechanism from its locked state to its unlocked state; and a driving signal to the driving mechanism, thereby displacing the card tray from its closed position into its open position.

According to a further aspect of the presently disclosed subject matter there is disclosed an electronic card assembly for use with an electronic device having a device housing with a housing external surface and a control unit. The electronic card assembly is configured to be disposed in said device housing and comprising:
a card housing configured with a housing opening;
a card tray having a card receiving space for accommodating an electronic card, said card tray being slidably displaceable between a closed position in which it is at least partially disposed within the card housing, and an open position in which it projects from the card housing to an extent greater than in said closed position;
a locking mechanism configured between a locked state in which said card tray is arrested in its closed position and an unlocked state in which the card tray is free to be displaced;
a driving mechanism configured for displacing the card tray at least from its closed position into its open position;
wherein said locking mechanism is configured for communicating with said control unit and receiving an unlocking signal therefrom so as to change the state of the locking mechanism from its locked state to its unlocked state; and
wherein said driving mechanism is configured for communicating with said control unit and receiving a driving signal therefrom so as to displace the card tray from its closed position to its open position.

According to a particular example of the presently disclosed subject matter, the electronic device is a mobile phone, and the electronic card is a SIM card or a memory card (e.g. an SD card). The electronic device of the presently disclosed subject matter is configured for electronically controlling locking and unlocking of the card tray in its closed position, so as to prevent and allow extraction of the card from the electronic device, respectively. Opposed to manual locking mechanisms know in the art, the locking and the unlocking mechanism of the presently disclosed subject matter is electronically controllable by the control unit and respective software embedded therein. The electro-mechanical locking mechanism of the presently disclosed subject matter can restrict unwanted physical access to the electronic card (e.g., extraction and theft of the card) by anyone having physical access to the electronic device since the card tray can be unlocked in its closed position only by electronic signals initiated by a user having access to respective software of the control unit (e.g., when the user interface of the device is unlocked), rather than manual unlock of the card tray, as know in the art. The electronic control of the locking mechanism provides an additional security level to the information stored on the electronic card (e.g., identification information pertaining to the user of the device).

Any one or more of the features, designs and configurations below can be incorporated in the electronic card assembly and/or the electronic device according to the presently disclosed subject matter, independently or in various combinations thereof.

The locking mechanism can comprise a locking member engageable with an arresting portion of the card tray for arresting the card tray at its closed position, whereby the locking member can be configured to engage the arresting portion to thereby prevent displacement of the card tray.

The locking member can be displaceable between an extended, locked position associated with the locked state of the locking mechanism and a retracted, unlocked position associated with the unlocked state of the locking mechanism.

The locking mechanism can be configured with a first biasing member configured for biasing said locking member toward its normally extended position.

The first biasing member can comprises one of a compression spring and a torsion spring.

The arresting portion can constitute a portion of an arresting recess formed in a side wall of the card tray and configured for receiving the locking member therein in at locked state of the locking mechanism.

The arresting portion can be associated with the locking mechanism so that displacement of the card tray from its open position to its closed position can be configured to induce engagement of the locking member with the arresting portion and displacement thereof into said arresting recess toward its extended position, thereby applying a pulling force on the arresting portion by said locking member and causing said card tray to assume its closed position.

The electronic card assembly can comprise a sensing mechanism in electronic communication with the control unit. The sensing mechanism can be configured for sensing displacement of the card tray from its open position toward its closed position and generating a closing signal. The control unit can be configured for receiving said closing signal, generating a locking signal to the locking mechanism and outputting the locking signal to the locking mechanism, thereby causing the locking mechanism to assume its locked state.

The locking mechanism can be configured with a first actuator in electronic communication with the control unit, configured for receiving said unlocking signal and causing the locking mechanism to assume its unlocked state based on the received unlocking signal.

The first actuator can be configured for receiving said locking signal, and causing the locking mechanism to assume its locked state based on the received locking signal.

The first actuator can comprise one of a linear motor, a rotary motor, a servo motor and a solenoid.

The control unit can be configured for outputting the unlocking signal and the displacing signal simultaneously. The driving mechanism can comprise a driving member configured for engaging an engagement portion of the card tray and applying a pushing force on the engagement portion when displacing the card tray from its closed position to its open position.

An engagement portion can be disposed at a rear wall of the card tray.

The driving mechanism can be configured for displacing the card tray from its open position into its close position.

The driving mechanism can comprise a second actuator in electronic communication with said control unit for receiving said driving signal.

The second actuator can comprise one of a linear motor, a rotary motor, a servo motor and a solenoid.

The first actuator and the second actuator can constitute a common single actuator configured for simultaneously causing the locking mechanism to change its state between the locked state and the unlocked state, and causing the driving mechanism to displace the card tray from its closed position into its open position.

The driving mechanism can comprise a second biasing member configured for normally biasing said driving member toward said engagement portion.

The second biasing member can comprise one of a leaf spring, compression spring and a torsion spring.

The locking mechanism and the driving mechanism can be integrated into a common locking-driving mechanism configured for simultaneously performing the operations of the locking mechanism and of the driving mechanism.

In particular, in the locking-driving mechanism, the locking member and the driving member can be interconnected therebetween by a bridging member, and forming together a lever member.

The bridging member can be configured with a pivot so as to allow the lever member to pivotally rotate between a first position associated with the locked state of the locking mechanism and the closed position of the card tray and a second position associated with the unlocked state of the locking mechanism and the open position of the card tray.

The single actuator and the lever member can be associated therebetween by a worm drive.

The electronic device can comprise: a displaying unit in electronic communication with the control unit, configured for displaying to a user an unlocking option for changing the state of the locking mechanism to the unlocked state; and an input unit in electronic communication with the control unit, configured for receiving a user opening instruction of the displayed unlocking option and forwarding said user unlocking instruction to said control unit so as to generate said unlocking signal.

The user opening instruction can be associated with authentication of the user by an authentication signal generated by one or more of the following authentication techniques: a pass code (e.g. digits, letters, combinations thereof, a pattern), fingerprint, face recognition, retina recognition, iris recognition, Near Field Communication signal, and voice print.

The communication between the control unit and the locking mechanism can be electronic or magnetic.

According to a further aspect of the presently disclosed subject matter there is disclosed a method for using an electronic device comprising: a device housing; an electronic card assembly disposed in said device housing and comprising: a card housing configured with a housing opening; a card tray having a card receiving space for accommodating an electronic card, said card tray being slidably displaceable between a closed position in it is at least partially disposed within the card housing, and an open position in which it projects from the card housing to an extent greater than in said closed position; a locking mechanism; a driving mechanism configured for displacing the card tray at least from its closed position into its open position; and a control unit disposed in said device housing and in communication with the locking mechanism and with the driving mechanism; said method comprising steps of:
generating an unlocking signal by said control unit;
generating a driving signal by said control unit;
outputting the unlocking signal to the locking mechanism;
outputting the driving signal to the driving mechanism;
receiving said unlocking signal by said locking mechanism, and thereby changing the state of the locking mechanism from a locked state in which said card tray is arrested in its closed position to an unlocked state in which the card tray is free to be displaced from its closed position to its open position; and
receiving said driving signal by said driving mechanism, and thereby displacing the card tray from its closed position into its open position.

The method can comprise a step of displacing said card tray from its open position to its closed position.

The electronic card assembly can comprise a sensing mechanism in electronic communication with the control unit, and the method can comprise steps of:
sensing by said sensing mechanism displacement of the card tray from its open position toward its closed position;
generating a closing signal by said sensing mechanism;
receiving said closing signal by said control unit;
generating a locking signal by said control unit; and
outputting the locking signal to the locking mechanism, thereby causing the locking mechanism to assume its locked state.

The steps of outputting the unlocking signal and outputting the driving signal can be performed by the control unit simultaneously.

The method can comprise steps of generating a driving signal said control unit and outputting the driving signal to the driving mechanism, and thereby changing the state of the driving mechanism from its closed state to its open state.

The electronic device can comprise: a displaying unit in electronic communication with the control unit; and an input unit in electronic communication with the control unit, and the method can comprise steps of:
displaying to a user an unlocking option on said displaying mechanism;
receiving a user unlocking instruction of the displayed opening option; and
forwarding said user unlocking instruction to said control unit so as to generate said unlocking signal, and thereby causing said locking mechanism to assume its unlocked state.

The method can comprise a step of performing authentication of the user upon said user opening instruction by at least one of a password, fingerprint, face recognition, retina recognition, iris recognition, Near Field Communication signal, and voice print.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a front view of an electronic device, in accordance with one example of the presently disclosed subject matter;

FIG. 2 is a schematic view of the electronic device of FIG. 1;

FIG. 3A is a front perspective view of an electronic card assembly at a locked state of its locking mechanism, in accordance with a first example of the presently disclosed subject matter;

FIG. 3B is the electronic card assembly of FIG. 3A, with a card housing removed therefrom;

FIG. 3C is a rear perspective view of the electronic card assembly of FIG. 3A;

FIG. 3D is a front perspective view of the electronic card assembly of FIG. 3A at an unlocked state of its locking mechanism;

FIG. 3E is the electronic card assembly of FIG. 3D, with a card housing removed therefrom;

FIG. 3F is a rear perspective view of the electronic card assembly of FIG. 3D;

FIG. 4A is a front perspective view of an electronic card assembly at a locked state of its locking mechanism, in accordance with a second example of the presently disclosed subject matter;

FIG. 4B is the electronic card assembly of FIG. 4A, with a card housing removed therefrom;

FIG. 4C is a rear perspective view of the electronic card assembly of FIG. 4A;

FIG. 4D is a front perspective view of the electronic card assembly of FIG. 4A at an unlocked state of its locking mechanism;

FIG. 4E is the electronic card assembly of FIG. 4D, with a card housing removed therefrom;

FIG. 4F is a rear perspective view of the electronic card assembly of FIG. 4D;

FIG. 5A is a front perspective view of an electronic card assembly at a locked state of its locking mechanism, in accordance with a third example of the presently disclosed subject matter;

FIG. 5B is a rear-bottom perspective view of the electronic card assembly of FIG. 5A;

FIG. 5C is a front perspective view of the electronic card assembly of FIG. 5A at an unlocked state of its locking mechanism; and

FIG. 5D is a rear-bottom perspective view of the electronic card assembly of FIG. 5C.

### DETAILED DESCRIPTION OF EMBODIMENTS

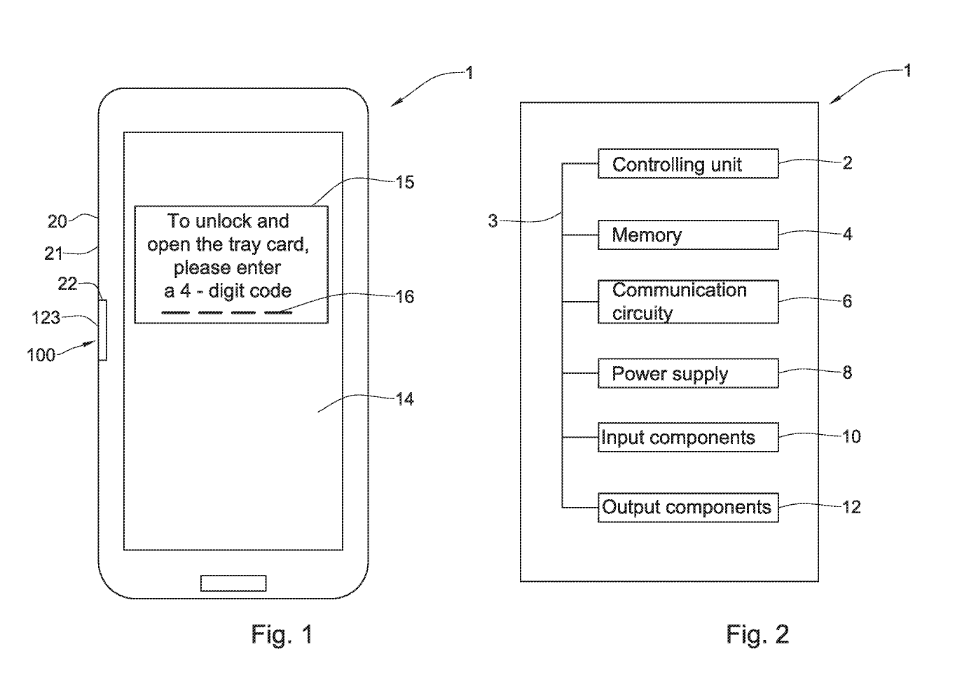

Attention is first directed to FIGS. 1 and 2 of the drawings, illustrating an electronic device in the form of a mobile phone, generally designated 1. As shown in FIG. 1, the mobile phone 1 includes a device housing 20 and a touch screen 14 configured to receive input information through a user's touch of a display screen and to provide visual information to a user via that same display screen. The mobile phone 1 is further configured with an electronic card assembly in the form of a SIM card assembly 100 having a card tray (not shown) with a tray external surface 123. The card tray is configured for accommodating a SIM card and to be received within an aperture 22 formed in the housing 20, so that the tray external surface 123 is aligned with a housing external surface 21 of the housing 20.

As shown in FIG. 2, illustrating a schematic view of the mobile phone 1, the mobile phone 1 includes a control unit 2 having a processor, a memory 4, communication circuitry 6, a power supply 8, input components 10, and output components 12. The mobile phone 1 further includes a bus 3 that provides wired communication links for transferring data and/or power to, from, or between the above components of the mobile phone 1. The control unit 2 includes processing circuitry operative to control the operations of the components of the mobile phone 1. For example, the control unit 2 is configured for running operating system applications, firmware applications, or any other applications. For example, the control unit 2 is able to run a user interface program stored in the memory 4 so as to receive input signals from the input components 9 and provide output signals to the output components 11. The memory 4 can include, for example, a hard-drive, a flash memory, a read-only memory (“ROM”), a random access memory (“RAM”), any other suitable type of storage component, or any combination thereof. The memory 4 is configured to storage all the data which is necessary for the operation of the mobile phone 1. The communications circuitry 6 is configured to allow the mobile phone 1 to communicate with one or more other electronic devices or servers using any suitable communications protocol. The power supply 8 (e.g., a battery) is configured to provide power to one or more of the components of mobile phone 1. The input components 10 can be configured to provide one or more dedicated control functions for making selections or issuing commands associated with operating the mobile phone 1, and can be for example, a touch pad, a dial, a touch screen, one or more buttons of a keyboard, a mouse, a microphone, a camera, a sensor. The output components 12 are configured to present or provide graphical or audible information to a user of mobile phone 1, and can be a visual display, audio speakers, headphones, etc. It should be indicated that at least one of the input components and at least one of the output components may be a single input/output (“I/O”) component. The touch screen 14 is an example of such I/O component.

As it will be explained in details below, the SIM card assembly 100 is electronically connected to the control unit 2 and to the power supply 8, and is controllable by the control unit 2 upon user's respective instructions received via the touch screen 14.

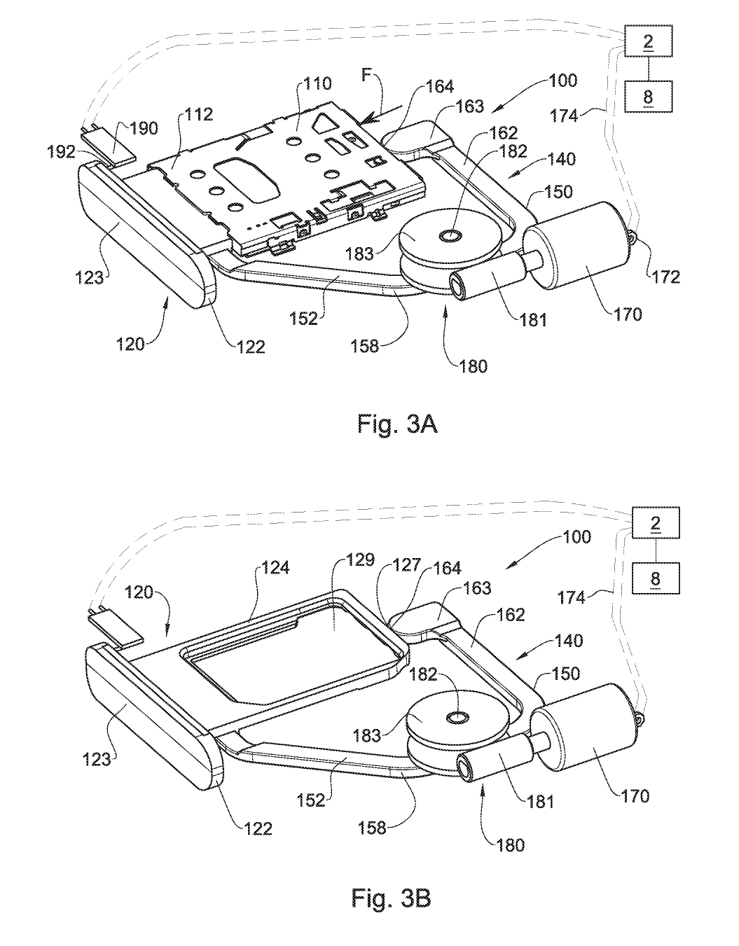

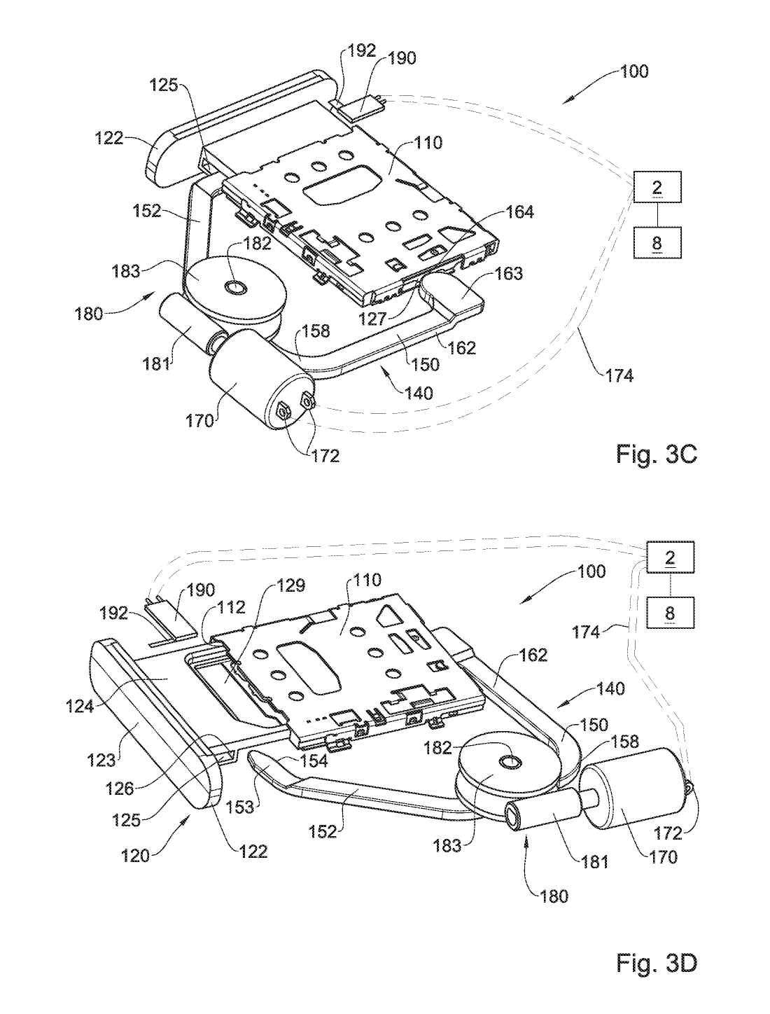

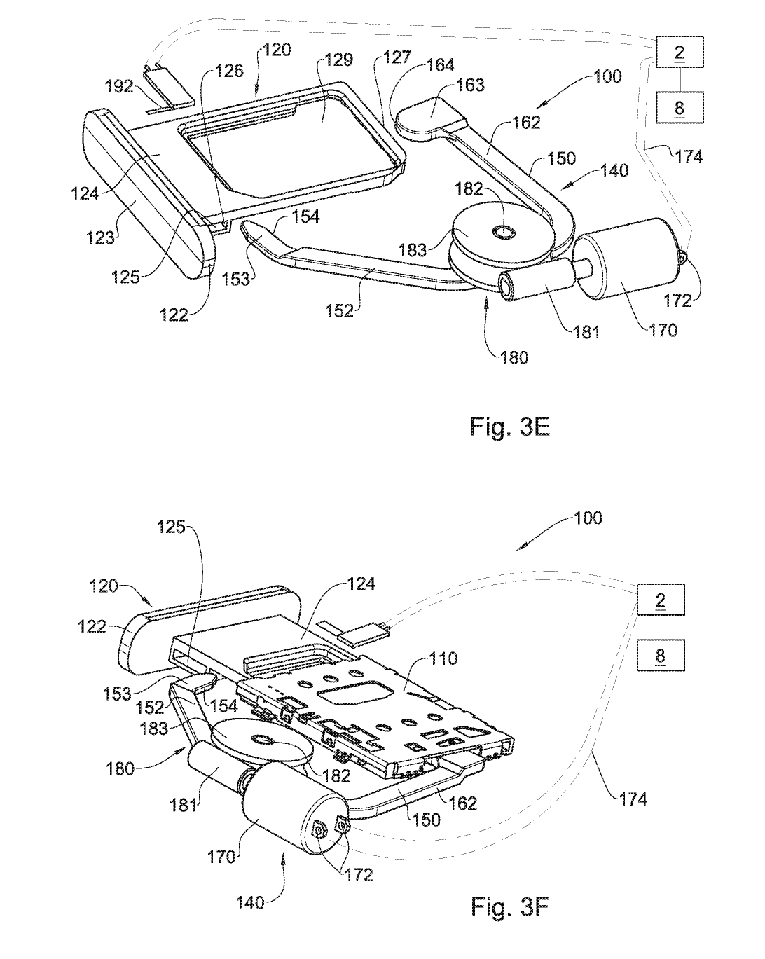

Reference is now made to FIGS. 3A-3F, illustrating a first example of the presently disclosed electronic card assembly in the form of the SIM card assembly 100. As explained above, the SIM card assembly 100 is configured to be accommodated within the mobile phone 1. The SIM card assembly 100 comprises a card housing 110 configured with a housing opening 112, a card tray 120, a locking-driving mechanism 140 having a lever member 150.

The card tray 120 is structured of a tray end 122 having the above mentioned tray external surface 123 and a tray body 124 having a card receiving space 129 for accommodating a SIM card (not shown) therein. The card tray 120 is slidably displaceable between a closed position (shown in FIGS. 3A-3C) in which the card receiving space 129 is received within the card housing 110 and the tray external surface 123 is aligned with the housing external surface 21 (as shown in FIG. 1), and an open position (shown in FIGS. 3D-3F) in which the card tray 120 projects from the card housing 110 to an extent greater than in the closed position.

The lever member 150 is structured of three interconnected and integrated members: a locking member 152, a driving member 162 and a bridging member 158 disposed therebetween.

The locking-driving mechanism 140 of the first example constitutes integration of two separate mechanisms of the presently disclosed subject matter, i.e., a locking mechanism and a driving mechanism, which according to the particular example, operate simultaneously in a single mechanism.

The locking-driving mechanism 140 comprises the lever member 150, an actuator in the form of a linear DC motor 170, and a worm drive 180 configured for mechanically associating between the DC motor 170 and the lever member 150. The worm drive 180 is composed of a worm 181 mounted to the DC motor 170 and a worm gear 183 seated on a pivot 182 and mounted to the bridging member 158 of the lever member 150. Linear movement of the worm 181 by the DC motor 170 is configured for rotating the worm gear 183 about the pivot 182 between a first position of FIGS. 3A-3C and a second position of FIGS. 3D-3F.

In general, the locking-driving mechanism 140 is configured for assuming two states: a locked state (shown in FIGS. 3A-3C) in which the card tray 120 is arrested in its closed position by the locking member 152; and an unlocked state (shown in FIGS. 3D-3F) in which the card tray 120 is free to be displaced from its closed position to its open position. According to the present example, the locked state is associated with a closed state of the locking-driving mechanism 140, in which the card tray 120 is in its closed position, and the unlocked state is associated with an open state of the locking-driving mechanism 140, in which the card tray 120 is in its open position. However, according to other examples in which the locking-driving mechanism 140 is constituted by two separate mechanisms, i.e., a locking mechanism and a driving mechanism, the unlocked state of the locking mechanism is not necessarily associated with the open state of the driving mechanism. In other words, the card tray 120 may be free to be displaced from its closed position (i.e., the unlocked state), however still be in its closed position.

The locking member 152 has a locking end 153 (shown in FIGS. 3D-3F) configured for arresting the card tray 120 in its closed position.

The card tray 120 is configured with an arresting recess 125 formed in a side wall of the card tray 120 and configured for receiving the locking end 153 therein in the locked state of the locking-driving mechanism 140.

The arresting recess 125 is configured with an arresting portion 126 (shown in FIGS. 3D and 3E) which is a portion of an internal wall of the arresting recess 125, and the locking end 153 is configured with a locking portion 154.

The arresting portion 126 is associated with the locking-driving mechanism 140 so that in the locked state, the locking end 153 is aligned with the arresting portion 126 so that during an attempt to displace the card tray 120 from its closed position to its open position, the locking portion 154 is configured to engage the arresting portion 126 to thereby obstruct of the card tray 120 and prevent its displacement towards the open position.

Upon electronic operation of the DC motor 170, the locking member 152 is displaceable between an extended position associated with the locked state of the locking-driving mechanism 140 and a retracted position associated with the unlocked state of the locking-driving mechanism 140. In the extended position, the locking end 153 is received in the arresting recess 125 (shown in FIGS. 3A-3C), and in the retracted position, the locking end 153 is disengaged from the arresting recess 125.

The driving member 162 is configured with a driving end 163 having a driving portion 164 configured for engaging an engagement portion 127 disposed at a rear wall of the card tray 120 (shown in FIGS. 3C and 3E). Upon electronic operation of the DC motor 170, the state of the locking-driving mechanism 140 is changed from its closed state to its open state, and in particular, the lever member 150 is rotated so that the driving end 163 engages the engagement portion 127 and applies a pushing force F (shown in FIG. 3A) thereon, and thereby displaces the card tray 120 from its closed position to its open position.

According to another example in which the locking-driving mechanism 140 is constituted by two separate mechanisms, i.e., a locking mechanism and a driving mechanism, each of these mechanisms may have its own actuator (e.g., a DC motor) controllable independently by the control unit 2. However, according to the example of FIGS. 3A-3F, in which the above two mechanisms are a single locking-driving mechanism, the DC motor 170 constitutes a common actuator configured for causing the locking-driving mechanism 140 to change its state between the locked and closed state and the unlocked and open state by simultaneously displacing the locking end 153 and the driving end 163.

As mentioned above, the SIM card assembly 100 is electronically connected to the control unit 2 and to the power supply 8, and is controllable by the control unit 2 upon user's respective instructions received via the touch screen 14. In particular, this electronic connection is provided by electronic connection of the DC motor 170 with the control unit 2 and the power supply 8 by means of connectors 172 and wiring 174. The control unit 2 is configured for generating an unlocking signal and outputting the unlocking signal to the DC motor 170, thereby moving the warm 181 in the forward direction which rotates the lever member 140, and thereby changing the state of the locking-driving mechanism 140 from its locked state to its unlocked state. According to the particular example of FIGS. 3A-3F in which the locking mechanism and the driving mechanism are the single locking-driving mechanism 140, the unlocking signal is also a driving signal, and these two signals eventually constitute the same signal which is transferred from the control unit 2 to the DC motor 170 for changing the state of the locking-driving mechanism 140 from its closed state (and locked state) to its open state (and unlocked state).

The electronic card assembly further comprises a sensing mechanism 190 which is in electronic communication with the control unit 2 by wiring 194. The sensing mechanism 190 includes a mechanical switch 192 having a pressed position (in FIGS. 3A-3C) and an unpressed position (in FIGS. 3D-3F). In the closed position of the card tray 120, the switch 192 is in its pressed position, and when the card tray 120 is moved to its open position, the switch 192 automatically moves to its unpressed position by means of a spring disposed within the sensing mechanism 190. Upon manual displacement of the card tray from its open position to its closed position by a user, the switch is moved to its pressed position. This causes the sensing mechanism 190 to sense the above displacement and to generate a closing signal to the control unit 2. The control unit 2 in turn, receives the closing signal and generates a locking signal and outputs the locking signal to the locking-driving mechanism 170. As a result of that, the locking-driving mechanism is instructed to assume its locked and closed state. In particular, the locking signal is an electronic signal to the DC motor 170 that instructs the DC motor 170 to move the worm 181 in the backward direction. Movement of the worm 181 in the backward direction induces the level 140 to rotate so that the locking end 153 is moved toward the arresting recess 125 and the driving end 163 is moved in the backward direction, toward the position of FIGS. 3A-3C.

It should also be indicated that as a result of the movement of the locking end 153 toward the arresting recess 125, the locking portion 154 engages the arresting portion 126. During this dynamic engagement, the rotation of the lever 140 causes the locking portion 154 to apply a pulling force on the arresting portion 125, and facilitating in drawing the card tray 120 to assume its closed position. In other words, the above described user-initiated manual operation of pushing the card tray 120 to its closed position, results in automatic operation of drawing the card tray to the closed position by the lever 140.

Reference is now made again to FIG. 1 is which the mobile phone 1 is illustrated. The mobile phone 1 has a user-identification application for allowing the user to instruct the control unit to unlock and open the card tray 120. This application has a user interface 15 which is presented on the touch screen 14 for identifying the user prior to the unlocking and the opening of the card tray 120. According to the example of FIG. 1, the user interface 15 includes an authentication process in which the user has to provide a 4-digit code in order to unlock and open the card tray 120. Upon insertion of the 4-digit code in the code-field 16, an authentication signal is transferred to the control unit 2, which provides respective instruction signals to the DC motor 170, thereby causing the locking-driving mechanism to assume its unlocked and open state. According to other examples, the authentication can be performed by one or more of the following procedures: fingerprint, face recognition, retina recognition, iris recognition, Near Field Communication signal, and voice print.

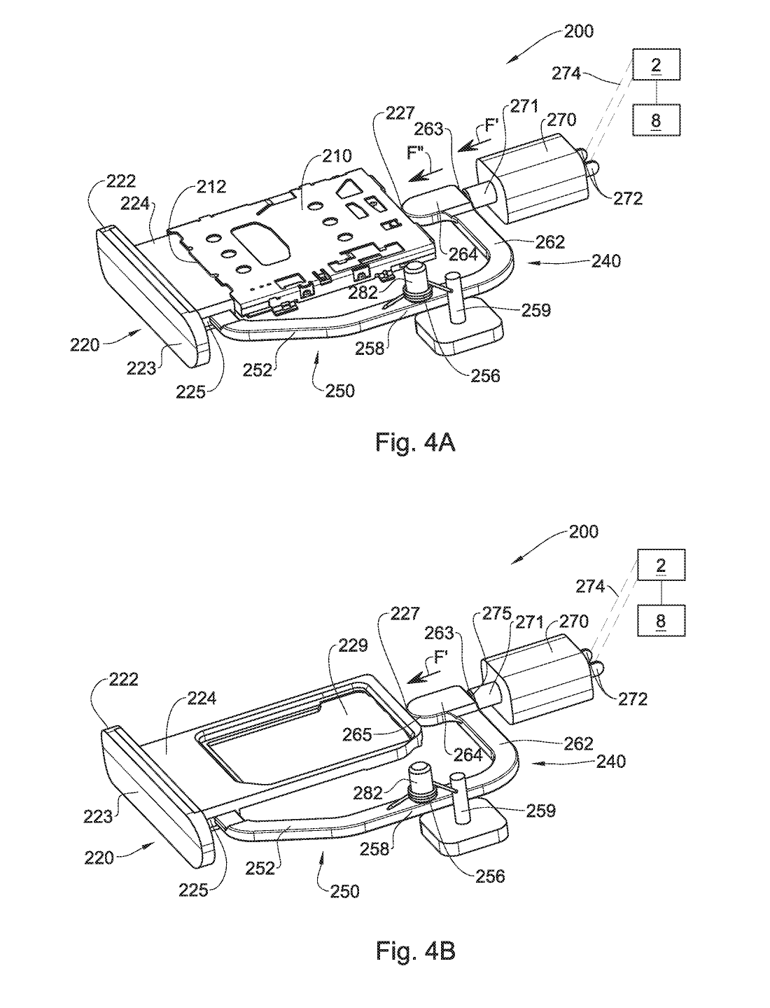

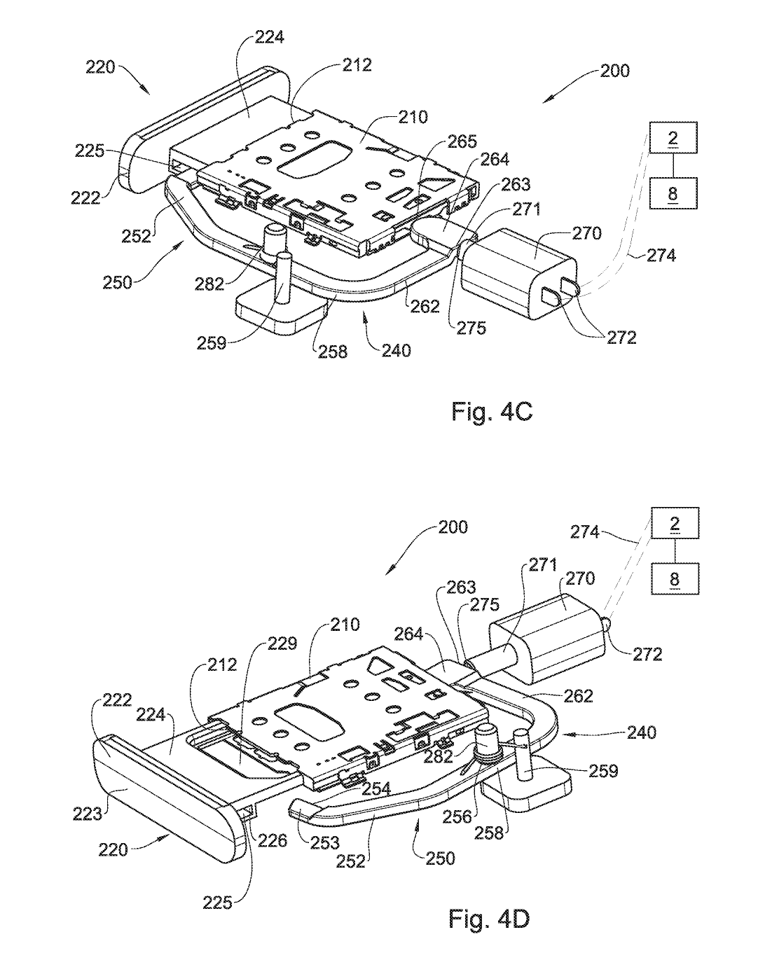

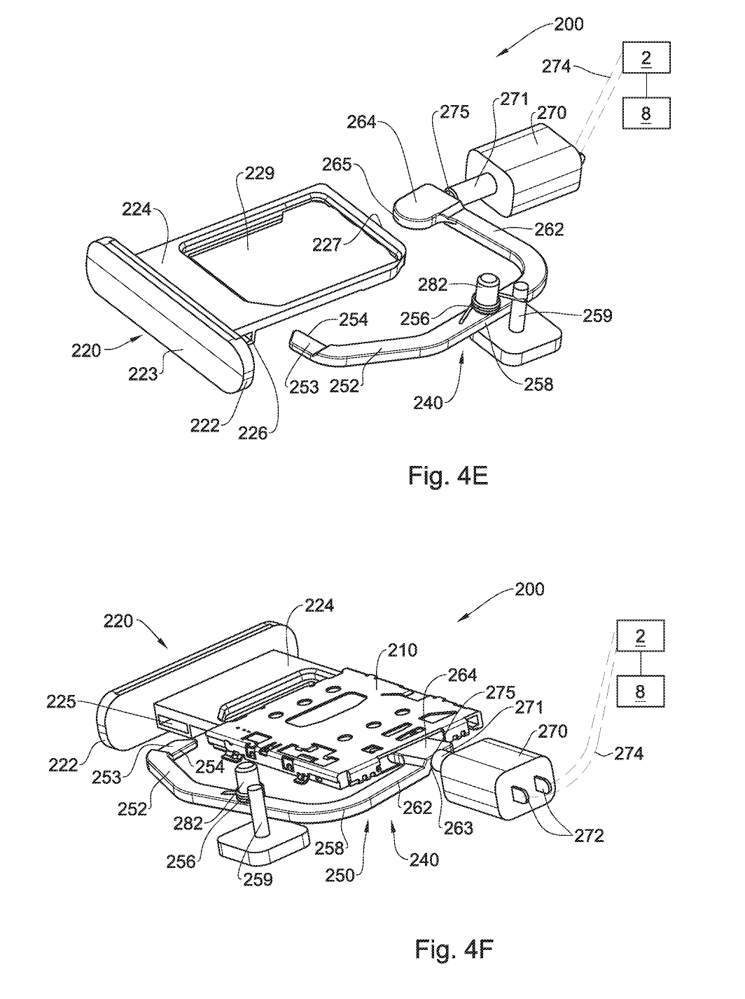

Reference is now made to FIGS. 4A-4F, illustrating a second example of the presently disclosed electronic card assembly in the form of the SIM card assembly 200. As the SIM card assembly 100, the SIM card assembly 200 is also configured to be accommodated within the mobile phone 1. The SIM card assembly 200 comprises a card housing 210 configured with a housing opening 212, a card tray 220, a locking-driving mechanism 240 having a lever member 250.

The card tray 220 is structured of a tray end 222 having a tray external surface 223 and a tray body 224 having a card receiving space 229 for accommodating a SIM card (not shown) therein. The card tray 220 is slidably displaceable between a closed position (shown in FIGS. 4A-4C) in which the card receiving space 229 is received within the card housing 210 and the tray external surface 223 can be aligned with the housing external surface 21, and an open position (shown in FIGS. 4D-4F) in which the card tray 220 projects from the card housing 210 to an extent greater than in the closed position.

The lever member 250 is structured of three interconnected and integrated members: a locking member 252, a driving member 262 and a bridging member 258 disposed therebetween.

The locking-driving mechanism 240 of the second example constitutes integration of two separate mechanisms of the presently disclosed subject matter, i.e., a locking mechanism and a driving mechanism, which according to the particular example, operate simultaneously in a single mechanism.

The locking-driving mechanism 240 comprises the lever member 250 and an actuator in the form of a linear solenoid 270. The solenoid 270 has a pushing arm 271 configured with a pushing end 275. The solenoid 270 is an electromagnetic device that converts electrical energy into a mechanical pushing force or motion of the pushing arm 271.

The level element 250 is seated on a pivot 282 at the region of the bridging member 258. Linear movement of the pushing arm 271 by the solenoid 270 is configured to apply a pushing force F′ (shown in FIGS. 4A and 4b) on a rear portion 263 of a driving portion 264 of the driving member 262, thereby rotating the lever member 250 about the pivot 282 between a first position of FIGS. 4A-4C and a second position of FIGS. 4D-4F. The locking-driving mechanism 240 further comprises a torsion spring 256 mounted on the pivot 282 and interconnected between the bridging element 258 and a support member 259. The torsion spring 256 is configured for reverting to lever member 250 to its first position, when a respective signal is received at the solenoid 270, and the pushing arm 271 stops applying the pushing force F′ on the rear portion 263.

In general, the locking-driving mechanism 240 is configured for assuming two states: a locked state (shown in FIGS. 4A-4C) in which the card tray 220 is arrested in its closed position by the locking member 252; and an unlocked state (shown in FIGS. 4D-4F) in which the card tray 220 is free to be displaced from its closed position to its open position. According to the present example, the locked state is associated with a closed state of the locking-driving mechanism 240, in which the card tray 220 is in its closed position, and the unlocked state is associated with an open state of the locking-driving mechanism 240, in which the card tray 220 is in its open position. However, according to other examples in which the locking-driving mechanism 240 is constituted by two separate mechanisms, i.e., a locking mechanism and a driving mechanism, the unlocked state of the locking mechanism is not necessarily associated with the open state of the driving mechanism. In other words, the card tray 220 may be free to be displaced from its closed position (i.e., the unlocked state), however still to be in its closed position.

The locking member 252 has a locking end 253 (shown in FIGS. 4D-4F) configured for arresting the card tray 220 in its closed position.

The card tray 220 is configured with an arresting recess 225 formed in a side wall of the card tray 220 and configured for receiving the locking end 253 therein in the locked state of the locking-driving mechanism 240.

The arresting recess 225 is configured with an arresting portion 226 (shown in FIGS. 4D and 4E) which is a portion of an internal wall of the arresting recess 225, and the locking end 253 is configured with a locking portion 254.

The arresting portion 226 is associated with the locking-driving mechanism 240 so that in the locked state, the locking end 253 is aligned with the arresting portion 226 so that during an attempt to displace the card tray 220 from its closed position to its open position, the locking portion 254 is configured to engage the arresting portion 226 to thereby obstruct of the card tray 220 and prevent its displacement towards the open position.

Upon operation of the solenoid 270 and respective forward movement of the pushing arm 271, the locking member 252 is displaceable from an extended position associated with the locked state of the locking-driving mechanism 240 and a retracted position associated with the unlocked state of the locking-driving mechanism 240. In the extended position, the locking end 253 is received in the arresting recess 225 (shown in FIGS. 4A-4C), and in the retracted position, the locking end 253 is disengaged from the arresting recess 225.

The driving portion 264 is further configured with a driving end 265 configured for engaging an engagement portion 227 disposed at a rear wall of the card tray 220 (shown in FIGS. 4C and 4E). Upon operation of the solenoid 270, the state of the locking-driving mechanism 240 is changed from its closed state to its open state, and in particular, the lever member 250 is rotated so that the driving portion 265 engages the engagement portion 227 and applies a pushing force F″ (shown in FIG. 4A) thereon, and thereby displaces the card tray 220 from its closed position to its open position.

According to another example in which the locking-driving mechanism 240 is constituted by two separate mechanisms, i.e., a locking mechanism and a driving mechanism, each of these mechanisms may have its own actuator (e.g., a DC motor or a solenoid) controllable independently by the control unit 2. However, according to the example of FIGS. 4A-4F, in which the above two mechanisms are a single locking-driving mechanism, the solenoid 270 constitutes a common actuator configured for causing the locking-driving mechanism 240 to change its state between the locked and closed state and the unlocked and open state by simultaneously displacing the locking end 253 and the driving end 264.

As shown in FIGS. 4A-4F, the SIM card assembly 200 is electronically connected to the control unit 2 and to the power supply 8, and is controllable by the control unit 2 upon user's respective instructions received via the touch screen 14. In particular, this electronic connection is provided by electronic connection of the solenoid 270 with the control unit 2 and the power supply 8 by means of connectors 272 and wiring 274. The control unit 2 is configured for generating an unlocking signal and outputting the unlocking signal to the solenoid 270, thereby moving the pushing arm 271 in the forward direction which rotates the lever member 240, and thereby changing the state of the locking-driving mechanism 240 from its locked state to its unlocked state. According to the particular example of FIGS. 4A-4F in which the locking mechanism and the driving mechanism are the single locking-driving mechanism 240, the unlocking signal is also a driving signal, and these two signals eventually constitute the same signal which is transferred from the control unit 2 to the solenoid 270 for changing the state of the locking-driving mechanism 240 from its closed state (and locked state) to its open state (and unlocked state).

Upon manual displacement of the card tray 220 from its open position to its closed position by a user, the engagement portion 227 engages the driving portion 265 and causes rotation of the lever member 250 to its first position, and the torsion spring 256 facilitates in this rotation. As a result of this rotation, the locking end 253 moves toward the arresting recess 225 and the locking portion 254 engages the arresting portion 226.

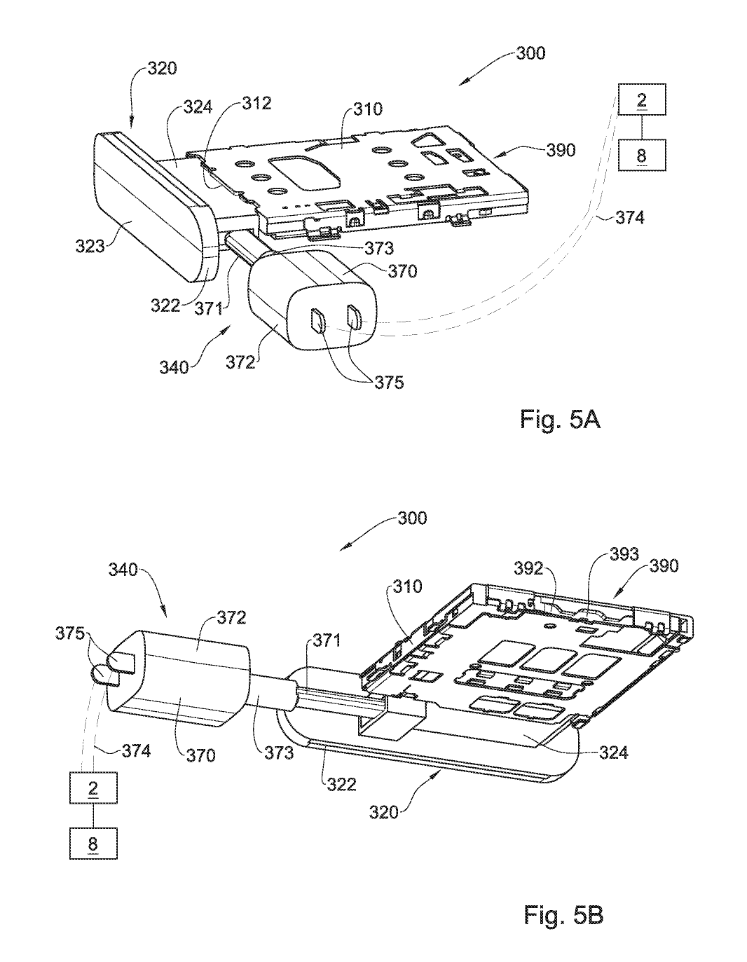

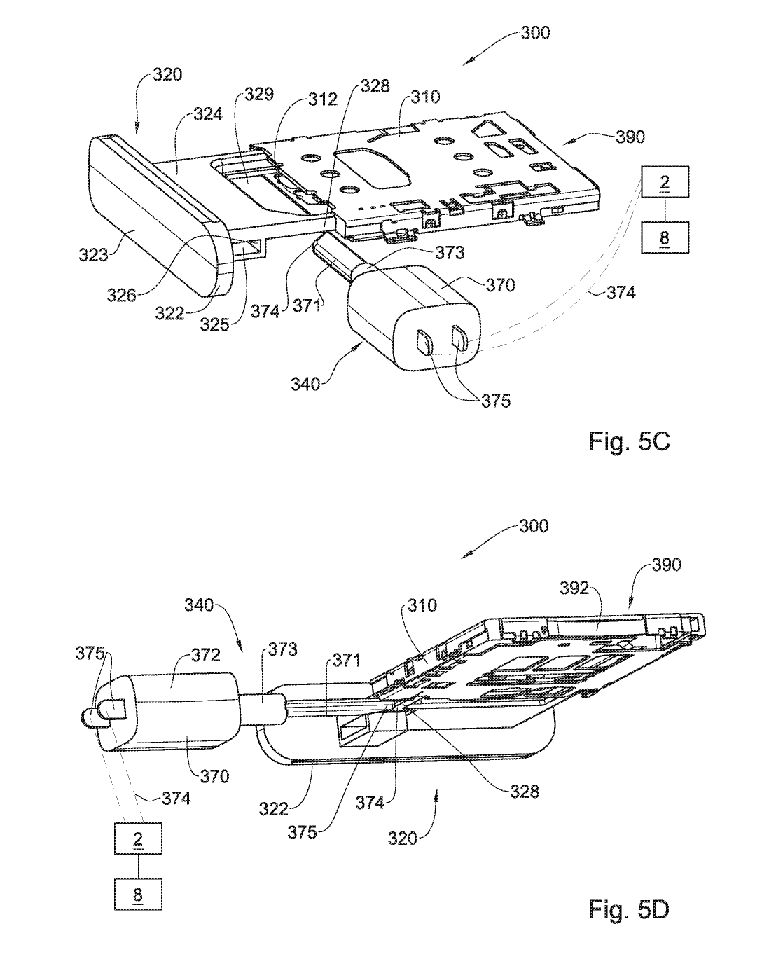

Reference is now made to FIGS. 5A-5D, illustrating a third example of the presently disclosed electronic card assembly in the form of the SIM card assembly 300. As the SIM card assemblies 100 and 200, the SIM card assembly 300 is also configured to be accommodated within the mobile phone 1. The SIM card assembly 300 comprises a card housing 310 configured with a housing opening 312, a card tray 320, a locking mechanism 340 and a driving mechanism 390 having an actuator in the form of a leaf spring 392 (shown in FIGS. 5B and 5D).

The card tray 320 is structured of a tray end 322 having a tray external surface 323 and a tray body 324 having a card receiving space 329 (shown in FIG. 5C) for accommodating a SIM card (not shown) therein. The card tray 320 is slidably displaceable between a closed position (shown in FIGS. 5A-5B) in which the card receiving space 329 is received within the card housing 310 and the tray external surface 323 can be aligned with the housing external surface 21, and an open position (shown in FIGS. 5C-5D) in which the card tray 320 projects from the card housing 310 to an extent greater than in the closed position.

The locking mechanism 340 has an actuator in the form of an electrical cylinder 370. The electrical cylinder 370 is configured with a locking arm 371 extending from a cylinder housing 372 through a sleeve member 373. The sleeve member 373 comprises a compression spring that constantly applies a pushing force on the locking arm 371 so as to cause it to assume its normal extended position (of FIGS. 5A and 5B). The electrical cylinder 370 is an electronic device that is configured to receive an electronic signal and convert this signal into a mechanical pulling force on the locking arm 371, causing it assume its retracted position (shown in FIGS. 5C and 5D). When this pulling force ceases, the compression spring causes the locking arm 371 to revert to its extended position (if possible).

In general, the locking mechanism 340 is configured for assuming two states: a locked state (shown in FIGS. 5A-5B) in which the card tray 320 is arrested in its closed position by the locking arm 371; and an unlocked state (shown in FIGS. 5C-5D) in which the card tray 320 is free to be displaced from its closed position to its open position. The driving mechanism 390 is configured for assuming two states: a closed state in which the leaf spring 392 has a straight and its central portion 393 applies a pushing force on a rear portion (not shown) of the tray body 324 while the card tray 320 is in its closed position, and an open state in which the leaf spring 392 has a curved shape and the card tray 320 is in its open position. According to the present example, the locked state of the locking mechanism is associated with the closed state of the driving mechanism 340, and the unlocked state of the locking mechanism is associated with the open state of the driving mechanism 340. However, according to other examples, the unlocked state of the locking mechanism is not necessarily associated with the open state of the driving mechanism. In other words, the card tray 320 may be free to be displaced from its closed position (i.e., the unlocked state), however still to be in its closed position.

The locking arm 371 has a locking end 374 (shown in FIGS. 5C and 5D) configured for arresting the card tray 320 in its closed position.

The card tray 320 is configured with an arresting recess 325 formed in a side wall of the card tray 320 and configured for receiving the locking end 374 therein in the locked state of the locking mechanism 340.

The arresting recess 325 is configured with an arresting portion 326 (shown in FIG. 5C) which is a portion of an internal wall of the arresting recess 325, and the locking end 374 is configured with a locking portion 375.

The arresting portion 326 is associated with the locking mechanism 340 so that in the locked state, the locking end 374 is aligned with the arresting portion 326 so that during an attempt to displace the card tray 320 from its closed position to its open position, the locking portion 375 is configured to engage the arresting portion 326 to thereby obstruct of the card tray 320 and prevent its displacement towards the open position.

Upon electronic operation of the electrical cylinder 370 and respective withdrawal of the locking arm 371, the locking arm 371 is displaceable from its extended position associated with the locked state of the locking mechanism 340 and a retracted position associated with the unlocked state of the locking mechanism 340. In the extended position, the locking end 374 is received in the arresting recess 325 (shown in FIGS. 5A-5B), and in the retracted position, the locking end 374 is disengaged from the arresting recess 325.

As a result of the retraction of the locking arm 371, the pushing force applied by the leaf spring 392 on the rear portion of the tray body 324, causes the card tray 320 to be displaced from its closed position to its open position.

As shown in FIGS. 5A-5B, the SIM card assembly 300 is electronically connected to the control unit 2 and to the power supply 8, and is controllable by the control unit 2 upon user's respective instructions received via the touch screen 14. In particular, this electronic connection is provided by electronic connection of the electrical cylinder 370 with the control unit 2 and the power supply 8 by means of connectors 375 and wiring 374. The control unit 2 is configured for generating an unlocking signal and outputting the unlocking signal to the electrical cylinder 370, thereby pulling the locking arm 371 to its retracted position, and thereby changing the state of the locking mechanism 340 from its locked state to its unlocked state and the state of the driving mechanism from its closed state to its open state. According to the particular example of FIGS. 5A-5B, the driving mechanism is a purely mechanical mechanism which is not directly controllable by the control unit 2, and in operated responsively to the electronic operation of the electrical cylinder 370.

When the card tray 320 is in its open position and no electronic instructions of the unlocking signal are provided to the electrical cylinder 370, the locking arm 371 is constantly biased by the compression spring disposed in the sleeve member 373 towards its extended position, and this causes the locking end 374 to engage a wall portion 329 of the card tray 320 (as shown in FIGS. 5C and 5D).

Upon manual displacement of the card tray 320 from its open position to its closed position by a user, the locking end 374 slides along the wall portion 329 until it reaches the arresting recess 325 and jumps therein. As a result of that, the locking mechanism 340 assumes its locked state.

It is appreciated that the above described user-identification application embedded on the mobile phone 1 for controlling the unlocking and opening of the SIM card assembly 100 can also be used for the same purpose with respect to the SIM card assembly 200 and the SIM card assembly 300.

1-46. (canceled)

47. An electronic device, comprising:
a device housing;
an electronic card assembly disposed in the device housing, the electronic card assembly including:
a card housing configured with a housing opening;
a card tray having a card receiving space for accommodating an electronic card, the card tray being slidably displaceable between a closed position in which the card tray is at least partially disposed within the card housing, and an open position in which the card tray projects from the card housing to an extent greater than in the closed position;
a locking mechanism configured between a locked state in which the card tray is arrested in the closed position and an unlocked state in which the card tray is free to be displaced; and
a driving mechanism configured for displacing the card tray at least from the closed position into the open position; and
a control unit in communication with the locking mechanism and with the driving mechanism, the control unit configured for outputting an unlocking signal to the locking mechanism, thereby changing the state of the locking mechanism from the locked state to the unlocked state; and a driving signal to the driving mechanism, thereby displacing the card tray from the closed position into the open position.

48. The electronic device according to claim 47, wherein the locking mechanism includes a locking member engageable with an arresting portion of the card tray for arresting the card tray at the closed position, wherein the locking member is configured to engage the arresting portion to thereby prevent displacement of the card tray.

49. The electronic device according to claim 48, wherein the locking member is displaceable between an extended, locked position associated with the locked state of the locking mechanism and a retracted, unlocked position associated with the unlocked state of the locking mechanism.

50. The electronic device according to claim 49, wherein the locking mechanism is further configured with a first biasing member configured for biasing the locking member toward a normally extended position thereof.

51. The electronic device according to claim 47, wherein the control unit is configured for outputting the unlocking signal and the displacing signal simultaneously.

52. The electronic device according to claim 47, wherein the driving mechanism further includes a driving member configured for engaging an engagement portion of the card tray and applying a pushing force on the engagement portion when displacing the card tray from the closed position to the open position.

53. The electronic device according to claim 47, wherein the locking mechanism includes a locking member engageable with an arresting portion of the card tray for arresting the card tray at the closed position, wherein the locking member is configured to engage the arresting portion to thereby prevent displacement of the card tray; wherein the driving mechanism further includes a driving member configured for engaging an engagement portion of the card tray and applying a pushing force on the engagement portion when displacing the card tray from the closed position to the open position; and wherein the locking member and the driving member are interconnected therebetween by a bridging member, and forming together a lever member.

54. The electronic device according to claim 53, wherein the bridging member is configured with a pivot so as to allow the lever member to pivotally rotate between a first position associated with the locked state of the locking mechanism and the closed position of the card tray and a second position associated with the unlocked state of the locking mechanism and the open position of the card tray.

55. An electronic card assembly for use with an electronic device having a device housing with a housing external surface and a control unit, the electronic card assembly configured to be disposed in the device housing, the electronic card assembly comprising:
a card housing configured with a housing opening;
a card tray having a card receiving space for accommodating an electronic card, the card tray being slidably displaceable between a closed position in which it is at least partially disposed within the card housing, and an open position in which the card tray projects from the card housing to an extent greater than in the closed position;
a locking mechanism configured between a locked state in which the card tray is arrested in the closed position and an unlocked state in which the card tray is free to be displaced; and
a driving mechanism configured for displacing the card tray at least from the closed position into the open position;
wherein the locking mechanism is configured for communicating with the control unit and receiving an unlocking signal therefrom so as to change the state of the locking mechanism from the locked state to the unlocked state;
wherein the driving mechanism is configured for communicating with the control unit and receiving a driving signal therefrom so as to displace the card tray from the closed position to the open position.

56. The electronic card assembly according to claim 55, wherein the locking mechanism includes a locking member engageable with an arresting portion of the card tray, for arresting the card tray at the closed position, wherein the locking member is configured to engage the arresting portion to thereby prevent displacement of the card tray.

57. The electronic card assembly according to claim 56, wherein the locking member is displaceable between an extended position associated with the locked state of the locking mechanism and a retracted position associated with the unlocked state of the locking mechanism.

58. The electronic card assembly according to claim 57, wherein the locking mechanism is further configured with a first biasing member configured for biasing the locking member toward a normally extended position thereof.

59. The electronic card assembly according to claim 55, wherein the control unit is configured for outputting the unlocking signal and the displacing signal simultaneously.

60. The electronic card assembly according to claim 55, wherein the driving mechanism further includes a driving member configured for engaging an engagement portion of the card tray and applying a pushing force on the engagement portion when displacing the card tray from the closed position to the open position.

61. The electronic card assembly according to claim 55, wherein the locking mechanism includes a locking member engageable with an arresting portion of the card tray, for arresting the card tray at the closed position, wherein the locking member is configured to engage the arresting portion to thereby prevent displacement of the card tray; wherein the driving mechanism further includes a driving member configured for engaging an engagement portion of the card tray and applying a pushing force on the engagement portion when displacing the card tray from the closed position to the open position; and wherein the locking member and the driving member are interconnected therebetween by a bridging member, and forming together a lever member.

62. The electronic card assembly according to claim 61, wherein the bridging member is configured with a pivot so as to allow the lever member to pivotally rotate between a first position associated with the locked state of the locking mechanism and the closed position of the card tray and a second position associated with the unlocked state of the locking mechanism and the open position of the card tray.

63. A method for using an electronic device including a device housing; an electronic card assembly disposed in the device housing, the electronic card assembly including a card housing configured with a housing opening; a card tray having a card receiving space for accommodating an electronic card, the card tray being slidably displaceable between a closed position in which the card tray is at least partially disposed within the card housing, and an open position in which the card tray projects from the card housing to an extent greater than in the closed position; a locking mechanism; a driving mechanism configured for displacing the card tray at least from the closed position into the open position; and a control unit in communication with the locking mechanism and with the driving mechanism; the method comprising:
generating an unlocking signal by the control unit;
generating a driving signal by the control unit;
outputting the unlocking signal to the locking mechanism;
outputting the driving signal to the driving mechanism;
receiving the unlocking signal by the locking mechanism, and thereby changing the state of the locking mechanism from a locked state in which the card tray is arrested in the closed position to an unlocked state in which the card tray is free to be displaced from the closed position to the open position; and
receiving the driving signal by the driving mechanism, thereby displacing the card tray from the closed position into the open position.

64. The method according to claim 63, further comprising displacing the card tray from the open position to the closed position.

65. The method according to claim 63, wherein the electronic card assembly further includes a sensing mechanism in electronic communication with the control unit, the method further comprising:
sensing by the sensing mechanism displacement of the card tray from the open position toward the closed position;
generating a closing signal by the sensing mechanism;
receiving the closing signal by the control unit;
generating a locking signal by the control unit; and
outputting the locking signal to the locking mechanism, thereby causing the locking mechanism to assume the locked state.

66. The method according to claim 63, wherein the outputting the unlocking signal and the outputting the driving signal are performed by the control unit simultaneously.
